(19) United States
(12) Patent Application Publication
(10) Pub. No.: US 2003/0197443 A1
(43) Pub. Date: Oct. 23, 2003

(54) Stator core and method of making

(76) Inventors: Robert Anthony Lawrence, Frankfort, IN (US); David L. Brown, Westfield, IN (US)

Correspondence Address: MARGARET A. DOBROWITSKY, DELPHI TECHNOLOGIES,INC., P.O.Box 5052, Troy, MI, 48007-5052, US

(21) Appl. No.: 10/124,504

(22) Filed: Apr. 17, 2002

(51) Int. Cl. H02K 1/18

(52) U.S. Cl. 310/218

(57) ABSTRACT

A stator core and method of making, the stator core and a plurality of separate poles are formed from lamination segments that are each stamped from a single piece of stock. The core includes a plurality of fixed pole segments and a plurality of engagement openings configured to receive and engage the separate pole segments. The method of making the stator core allows for maximum use of the material from which the laminations of the stator are stamped as well as an efficient use of the available space within the stator core. In addition, the method allows for maximum copper slot fill.

### TECHNICAL FIELD

This application relates generally to a stator core for an electric machine and method of making the same. In particular, this application relates to a stator core for a salient pole electric motor and a method of making.

### BACKGROUND

FIG. 1 of the drawings illustrates a cross sectional view of a salient pole switched reluctance machine. This machine can be operated as either an electric motor or generator. However, for the sake of convenience the term electric machine will be used throughout this specification though it is to be understood that the present application is applicable to electric generators and motors and combinations thereof.

The switched reluctance motor of FIG. 1 comprises a stator core 1 and a rotor 2 each having an appropriate number of salient poles 3 and 4, respectively. The stator core is made up of numerous metal laminations in a stack. In this type of electric machine the laminations are usually stamped from a blank of strip metal. As the general outer shape of each lamination will be circular there will be a significant amount of material left between stampings of laminations, which can only be cast aside as scrap metal. Although this scrap can, of course, be recycled, it is clearly desirable to utilize the strip metal with as little waste as possible.

Each salient stator pole 3 of the stator core carries an exciting coil 5. The coils 5 are wound from copper windings such that North (N) and South (S) poles are created alternately around the stator. This type of construction requires a considerable amount of copper and a winding machine that will add both to the weight and cost of the motor. In addition, there must be a sufficient amount of room between each winding to allow the insertion of the coils or the direct winding of the coils or the poles of the stator.

For example, the copper windings of the motor illustrated in FIG. 1 are wound about each lamination pole tooth to form a coil. The winding process or machine used for this design is called a needle winder. Copper wire is fed through a hardened and polished needle and then revolved around the pole tooth to form the coil. The needle requires space to go around pole tooth. Accordingly, the number of coils that can be installed per pole is limited depending by how close the adjacent pole tooth is and its coil set. As illustrated in FIG. 1, there is unused space between the adjacent coils.

### SUMMARY

It is an object of the present disclosure to provide an electric machine with a stator core that optimizes the use of the core material and copper windings in order to reduce the cost of manufacture.

It is also an object of the present disclosure to increase the slot fill (e.g. utilize more copper) of an electric machine.

A stator core and method of making, the stator core and a plurality of separate poles are formed from lamination segments that are each stamped from a single piece of stock. The core includes a plurality of fixed pole segments and a plurality of engagement openings configured to receive and engage the separate pole segments. The method of making the stator core allows for maximum use of the material from which the laminations of the stator are stamped as well as a finished stator with an efficient use of available space.

A stator core for an electric machine, comprising: an outer ring member defining an inner opening and having a plurality of first pole segments depending inwardly into the inner opening; a plurality of second pole segments each being secured to the outer ring member by inserting an engagement portion of the second pole segments into an engagement opening of the outer ring member, the engagement opening is positioned to face the inner opening and the engagement portion is configured to have a portion axially inserted into the engagement opening.

A method for manufacturing a stator core of an electric machine, comprising: stacking a plurality of ring segments upon each other, each ring segment having a plurality of pole segments depending inwardly into an opening defined by the ring segments, the stacked pole segments defining a plurality of first pole members; placing a coil on each of the first pole members; stacking a plurality of pole segments, each pole segment having an engagement portion configured to be received in an engagement opening of the ring segments, the stacked pole segments defining a plurality of second pole members; placing a coil on each of the second pole members; and inserting the engagement portion of the pole segments into the engagement openings of the ring member after the coils have been placed on the second pole members and after the coils have been placed on the first pole members.

The above-described and other features of the present disclosure will be appreciated and understood by those skilled in the art from the following detailed description, drawings, and appended claims.

### BRIEF DESCRIPTION OF THE DRAWINGS

FIG. 1 is a cross-section of a salient pole switched reluctance motor;

FIG. 2 is a top plan view of a template for stamping a stator lamination for use in an electric machine constructed according to the present application;

FIG. 3 is a top plan view of a stator core stamped in accordance with the present application;

FIG. 4 is a top plan view of the pole segments of the FIG. 2 template after stamping;

FIG. 5 is a top plan view illustrating the securement of the pole segments into the stator core;

FIG. 6 is a cross sectional view illustrating the winding of the coils about the fixed pole segments of the stator core;

FIG. 7 is a perspective view of a spool for a coil of the stator core;

FIG. 8 is a cross sectional view illustrating the winding of the coils about the pole segments of FIG. 4; and

FIG. 9 is a cross sectional view of a stator core constructed in accordance with an exemplary embodiment.

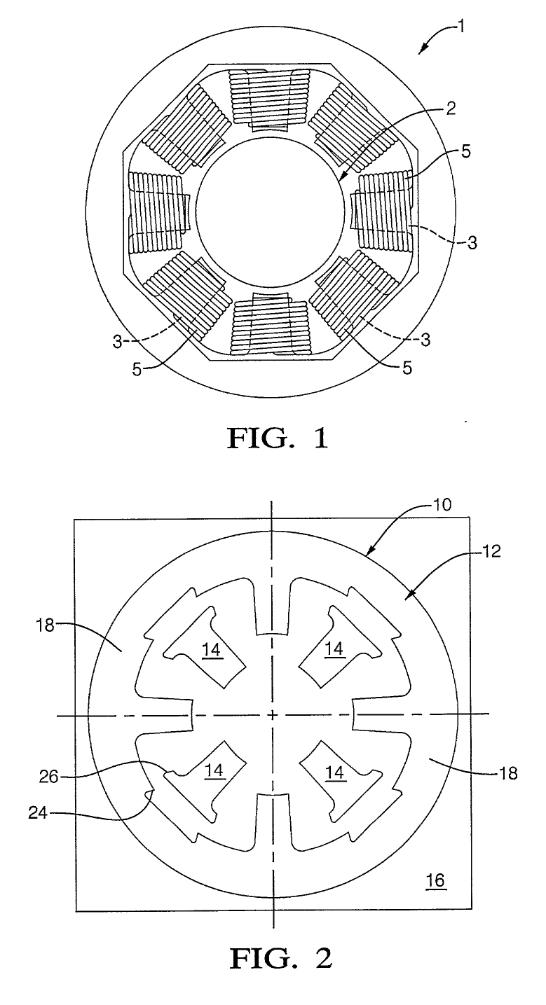

### DESCRIPTION OF THE PREFERRED EMBODIMENT

A stator core and method of making, the stator core and a plurality of separate poles are formed from lamination segments that are each stamped from a single piece of stock. The core includes a plurality of fixed pole segments and a plurality of engagement openings configured to receive and engage the separate pole segments. The fixed pole segments and the engagement opening are configured into an alternating configuration wherein each fixed pole segment has an engagement opening at either side. The method of making the stator core allows for maximum copper slot fill.

A coil is placed or wound about each of the fixed pole segments. Similarly, a coil is wound or placed upon each of the separate pole segments the separate pole segments and their coils are inserted axially into a plurality of engagement openings configured and positioned for receiving and retaining the separate pole segments and the complimentary coils. This configuration and method of assembly allows for economical use of the lamination material and judicious use of the real estate within the inner area of the stator core.

Referring now to FIG. 2, a template 10 for stamping a stator core segment 12 and a plurality of separate pole segments or teeth 14 are formed from a single piece of stock 16 is illustrated. An example of stock material 16 is steel, powder metal and equivalents thereof. Thus, and in accordance with the template of FIG. 2 each lamination or stamping would consist of five pieces as opposed to a single piece in a traditional lamination. Here four pole teeth are part of the main body and another four pole teeth are stamped independently through the same die. No additional material is needed because the additional four pole teeth are stamped from the waste material in the center of the stock material. All of the core pieces would be interlocked together as they are stamped to produce the desired core thickness.

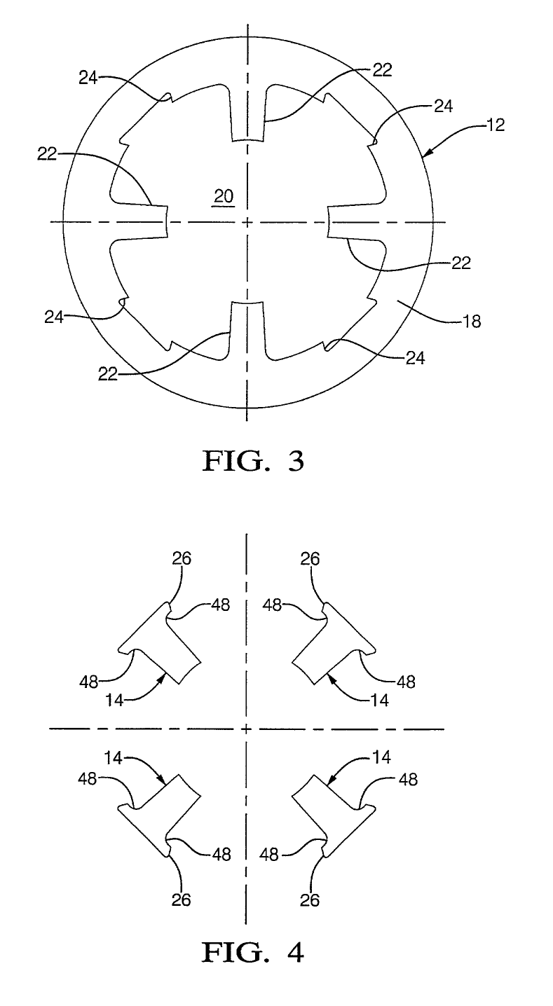

In accordance with an exemplary embodiment, and referring now to FIG. 3, stator core segment 12 comprises a circular ring member 18 defining a central opening 20. A plurality of fixed pole segments or pole teeth 22 depend inwardly into central opening 20, fixed pole segments 22 provide a means for receiving a copper winding or coil for use in the electric machine. FIG. 3 illustrates four fixed pole segments 22 however, it is contemplated that in accordance with the present disclosure and as applications may require the number of pole segments may vary.

In addition, and referring now to FIGS. 3-5, circular ring member 18 is configured to have a plurality of pole engagement openings 24. Pole engagement openings 24 are configured to receive an engagement portion 26 of separate pole segments 14. The engagement portion is configured to be received within the engagement opening as it is axially slid in. Engagement openings 26 have a dove tail configuration which allows axial insertion therein. Of course, the configuration of the engagement openings and the engagement portions may be varied to any configuration which allows for axial insertion. For example, a triangular configuration, a trapezoidal configuration, and any other type of dove tail arrangement (e.g. capable of being axially inserted in one direction and not another).

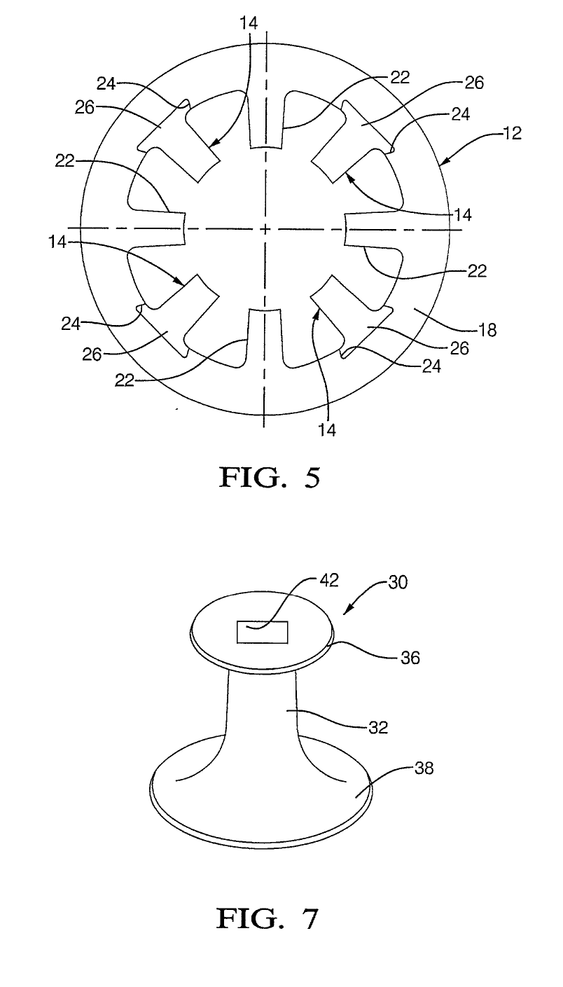

FIG. 5 illustrates the separate pole segments engaged in the engagement openings of ring member 18. It is noted however, that the separate pole segments will only be engaged within the engagement openings of ring member 18 after insertion of a coil upon each of the separate pole segments as will be more fully discussed below.

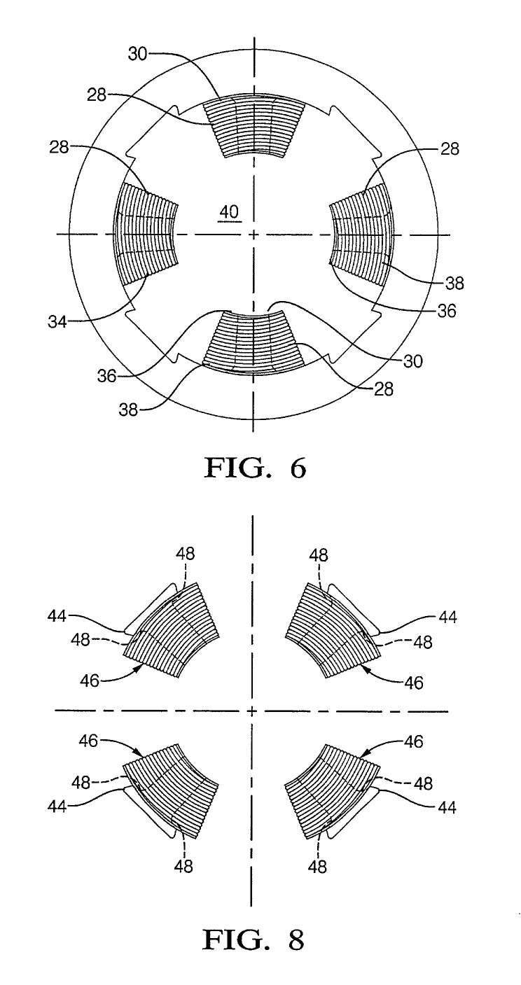

Referring now to FIG. 6, and after each of a plurality of ring members are positioned into a stack of a desired thickness, a plurality of coils 28 are located upon each of the fixed pole segments of the outer ring member.

Placement of the coils on the fixed pole segments is facilitated by either directly winding the coil onto the fixed pole segments by a winding machine or alternatively, winding the coil onto a spool configured for receipt onto the fixed pole segments. In the case of the later method and referring now to FIGS. 6 and 7, each coil 28 comprises a spool member or bobbin 30 having a spool surface 32 for receipt of a plurality of copper windings 34.

Spool member 30 is constructed out of an easily molded nonconductive material such as plastic. For example spool member 30 is an injection molded piece. Alternative materials for spool member 30 include but are not limited to the following: a NOMEX® arimid paper, a MYLAR® polyester film, a powder coat, an epoxy and equivalents thereof.

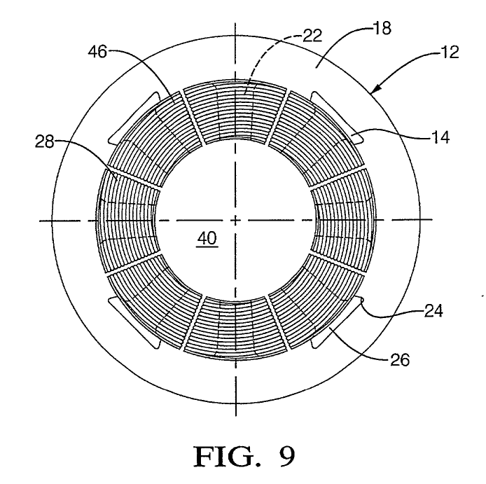

Spool surface 32 is disposed between an inner wall 36 and an outer wall 38 of spool member 30. Inner wall 36 is configured to have a lower profile as compared to outer wall 38. This allows for each coil 28 to have an angular configuration wherein the outer portion of coil 28 adjacent to outer wall 38 has more windings than the portion of coil 28 adjacent to inner wall 36. Accordingly, the assembled coil will have an increased width from inner wall 36 to outer wall 38. This configuration allows multiple coils to be positioned within the stator core while maximizing the allowable space (FIG. 9).

In addition, and in order to provide a more uniform fit with the circular configuration of the stator core and the inner opening defined by the stator core and coils, both inner wall 36 and outer wall 38 are configured to have an arcuate shape corresponding to the arc of ring member 18. Accordingly, and when the coils are inserted onto the fixed pole segments the inner walls of the coils define a portion of the outside diameter of an inner opening 40 of the stator core. Inner opening 40 is configured to rotatbly receive a rotor therein.

The arcuate shape of outer wall 38 allows the entire surface of outer wall 38 to be positioned adjacent or close to a surface of the ring member. This allows more uniform support of the coil as it is inserted onto the fixed pole segment. This type of arrangement would not be attainable if the ring member 18 was circular and the outer wall member was straight or vice versa.

Each spool member 30 includes an inner opening 42. Inner opening 42 is configured for receipt of the fixed pole segments of ring member 18. In an exemplary embodiment opening 42 is generally rectangular in shape to conform to the outside dimensions of the stack comprising the fixed pole segments. Of course, and as applications require, the fixed pole segments may define an alternative configuration such as a circular configuration wherein opening 42 is modified accordingly.

In one embodiment, the spool members are plastic bobbins constructed from two-pieces, which are snap fitted together wherein the joint is at the mid-core stack thickness.

Once the windings are wound onto the spool member, the same are inserted onto the fixed pole segments of ring member 18. Spool member 30 can be retained in its preferred location by numerous mechanical means.

Alternatively, the spool member with the coils winded thereon is simply inserted onto the fixed pole segments without the use of any adhesives and there is an interference fit between the spool member and the fixed pole segment. In yet another alternative the spool member includes a feature configure for receiving and/or engaging a complimentary feature of the pole segment it is being inserted on. In yet another alternative the opening of the spool member is smaller than the pole segments and the spool member is press fitted thereon.

Referring now to FIG. 8, a plurality of independent pole segments 44 are each formed from a plurality of stacked and laminated pole segments 14. Once all of the pole segments are stacked and laminated a coil 46 is positioned onto the pole segment to form a pole segment and coil assembly. Similar to the installation of the coils onto the fixed pole segments coils 46 are wound directly onto the pole segment or alternatively they are wound onto a spool that is configured to be received onto the pole segment.

In either application, the bottom portion of coil 46 makes contact with a shoulder portion 48 of pole segments 14. Shoulder portion 48 allows an engagement portion 26 to depend away from the outer wall of the spool containing coil 46. Accordingly, this allows engagement portion 26 to be received within engagement opening 24 while the outer wall of the spool is adjacent to the inner surface of ring 18.

Once this process is complete, and referring now to FIG. 9, each of the coil and pole segment assemblies are inserted into ring member 18 after the insertion of coils 28 onto the fixed pole segments by axially sliding the engagement portion 26 into engagement opening 24. This method of insertion allows multiple coils to be disposed upon pole segments in a circular arrangement while requiring a minimal amount of clearance space between each of the coils. Permanent securement of the engagement portion is attainable through the use of a tack weld or other equivalent securement means.

FIG. 9 illustrates eight coils arranged in a circular configuration for defining and an inner opening 40 configured for receipt of a rotor therein. Four of the eight coils are first installed onto fixed pole members 22 of outer ring member 18 and then the remaining four coils with their own respective pole segments are axially slid into engagement openings of the outer ring member.

The present disclosure allows a pole and coil configuration not presently attainable wherein each of the coils are positioned in a circular arrangement with a minimum amount of space between each of the coils. In addition, the present disclosure is also contemplated for use with an electric machine that may be configured to run as a motor as well as a generator.

In addition, the material costs for each motor using the stator core of the present disclosure should be reduced as there will be more copper and the actual motor size will also be able to be reduced. Additionally, manufacturing costs will also be reduced as high-speed bobbin winders will be used to wind the coils as opposed to slower in slot winding technologies.

Moreover, higher motor efficiency and performance will be attainable resulting in smaller overall motor packages, this will also allow for reduced material costs and more flexible packaging to be used in various applications. For example, an intended use is with break by wire calipers wherein the wheel well configuration allows for a limited amount of space for the electric machine to be inserted therein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A stator core for an electric machine, comprising:
an outer ring member defining an inner opening and having a plurality of first pole segments depending inwardly into said inner opening;
a plurality of second pole segments each being secured to said outer ring member by inserting an engagement portion into an engagement opening of said outer ring member, said engagement opening facing said inner opening and said engagement portion being configured to have a portion axially inserted into said engagement opening.

2. The stator core as in claim 1, further comprising:
a coil disposed on each of said plurality of first pole segments and said plurality of second pole segments.

3. The stator core as in claim 2, wherein each of said coils are wound about a bobbin configured to be received on each of said plurality of first pole segments and said plurality of second pole segments.

4. The stator core as in claim 3, wherein each of said coils has a first wall member and a second wall member, said first wall member being of a smaller dimension than said second wall member.

5. The stator core as in claim 4, wherein said first wall member and said second wall member are each configured to have an angular configuration that is similar to the angular configuration of said inner opening.

6. The stator core as in claim 5, wherein said second wall member defines a portion of an opening, said opening being positioned within said inner opening.

7. The stator core as in claim 6, wherein said opening is configured to rotatebly receive a rotor therein.

8. The stator core as in claim 6, wherein said bobbin is plastic.

9. A stator core for an electric machine, comprising:
an outer ring member defining an inner opening and having a plurality of first pole segments depending inwardly into said inner opening;
a plurality of second pole segments each being secured to said outer ring member by inserting an engagement portion into an engagement opening of said outer ring member, said engagement opening facing said inner opening and said engagement portion being configured to have a portion axially inserted into said engagement opening;
a plurality of coils each being wound upon a plastic bobbin having an inner opening configured to receive a portion of said plurality of first pole segments and said plurality of said second pole segments, wherein said plurality of coils are inserted upon said plurality of first pole segments and said plurality of said second pole segments prior to the insertion of said engagement portion into said engagement opening.

10. A method for manufacturing a stator core of an electric machine, comprising:
stamping a ring segment and a plurality of pole segments out of piece of stock, said ring segment defining an inner opening and having a plurality of fixed pole segments depending into said inner opening, said piece of stock having dimensions slightly larger than said ring segment and said plurality of plurality pole segments being stamped from the material comprising said inner opening.

11. The method as in claim 10, wherein said plurality of pole segments each have an engagement portion configured to be axially received with a complimentary engagement opening disposed along the periphery of said inner opening.

12. A method for manufacturing a stator core of an electric machine, comprising:
stacking a plurality of ring segments upon each other, each ring segment having a plurality of pole segments depending inwardly into an opening defined by said ring segments, said stacked pole segments defining a plurality of first pole members;
placing a coil on each of said first pole members;
stacking a plurality of pole segments, each pole segment having an engagement portion configured to be received in an engagement opening of said ring segments, said stacked pole segments defining a plurality of second pole members;
placing a coil on each of said second pole members; and
inserting said engagement portion of said pole segments into said engagement openings of said ring member after said coils have been placed on said second pole members and after said coils have been placed on said first pole members.
